(19) United States
(12) Patent Application Publication
(10) Pub. No.: US 2005/0237755 A1
(43) Pub. Date: Oct. 27, 2005

(54) Boat trailer auxiliary lighting apparatus method and system

(76) Inventor: Douglas Vause, Farr West, UT (US)

Correspondence Address: KUNZLER & ASSOCIATES, 8 EAST BROADWAY, SALT LAKE CITY, UT, 84111, US

(21) Appl. No.: 10/832,670

(22) Filed: Apr. 27, 2004

(51) Int. Cl. B60Q 1/00; F21S 8/10

(52) U.S. Cl. 362/485; 362/545

(57) ABSTRACT

An auxiliary lighting apparatus for a boat trailer includes a plurality of light-emitting diodes enclosed in a sealed, water-tight lighting assembly. In certain embodiments, a mounting element is constructed with a cavity that encloses and protects the lighting assembly and the mounting element mounts over standard dimension boat trailer bunk boards. In other embodiments, the mounting element is constructed to adjoin the edges of trailer bunk boards. The mounting element may also be constructed to function as a bumper or guide for a boat hull and may be constructed of a low-friction, mar-resistant material that eases loading and unloading operations and reduces marring of the boat hull. In one embodiment, the mounting element may be readily mounted or unmounted from the trailer bunk boards and the lighting assembly is configured to respond to control signals generated by a wireless controller that is uniquely associated with the light assembly.

### BACKGROUND OF THE INVENTION

1. Field of the Invention

The present invention relates to auxiliary lighting for a trailer. Specifically, the invention relates to apparatus, methods, and systems for providing auxiliary lighting for a boat trailer.

2. Description of the Related Art

Boat trailers are typically equipped with lights mounted on or near the rear bumper. These lights connect to the towing vehicle's electrical system to synchronize taillight, turn signal, brake, and backup functions with the towing vehicle's lights. State vehicle codes specify the distance these lights must be visible from the rear of the trailer, but because these lights are typically very close to the ground, they are usually obscured by any vehicle to the rear of the trailer. Usually, only the vehicle immediately following the trailer can see the trailer's brake or signal lights.

Some smaller boat trailers are not equipped with lights. Auxiliary lighting systems have been developed that can make trailers not equipped with lights conform to vehicle codes, and make all trailers more visible in traffic. FIG. 1 illustrates a typical prior art auxiliary lighting system 100. The prior art auxiliary lighting system 100 includes a boat 110, boat trailer 120, outboard motor 130, and an auxiliary signal light 140 that attaches to the outboard motor 130.

FIG. 2 illustrates an alternate prior art auxiliary lighting system 200. The alternate prior art auxiliary lighting system 200 includes components of the prior art auxiliary lighting system 100 and auxiliary signal lights 230a and 230b that mount on the boat 110. The alternate prior art auxiliary lighting system 200 has an advantage in that the auxiliary signal lights 230 are mounted high enough on the boat trailer 120 that they are not obscured by a vehicle following immediately behind the boat trailer 120. Both prior art auxiliary lighting systems 100 and 200 have the disadvantage that the auxiliary signal lights 140 and 230 must be attached to the boat 110 after it is loaded onto the boat trailer 120, and removed from the boat 110 before launching. Because the prior art auxiliary lighting systems 100 and 200 mount on the boat rather than the boat trailer, the prior art auxiliary lighting systems 100 and 200 do not facilitate use when the trailer is towed without a boat.

Various prior art auxiliary lighting systems mount at different locations on the boat or boat trailer, such as the boat propeller or on a bar or bracket that attaches to the boat. Because of the wide variation in boat and propeller designs, prior art auxiliary lighting systems may not mount easily on many boats, boat propellers, or boat trailers.

Aside from the inconvenience of having to mount the auxiliary signal lights on the boat when the boat is loaded on the trailer and removing the auxiliary signal lights when the boat is launched, not having auxiliary signal lights mounted on the boat trailer means that the auxiliary signal lights are not available to provide assistance when loading a boat in dark conditions. With auxiliary signal lights mounted on a boat trailer, the person steering the boat can more easily locate the trailer and steer toward it when the trailer is located in an unlighted boat launch area.

Prior art auxiliary lighting systems typically use incandescent light bulbs that must be replaced periodically and become hot during usage. Prior art systems therefore typically employ gaskets and removable covers to prevent water from entering the auxiliary signal light 140 and 230 and imploding the incandescent light bulbs or shorting the electrical connections associated therewith. Gaskets typically degrade over time, particularly when exposed to warm sunny conditions, and lose their ability to prevent water from penetrating light fixtures and corroding electrical connections. As a result boat users may be required to unplug the trailer lights from the vehicle when loading or unloading the boat to prevent shorts from occurring, or the signal lights from imploding upon contact with water.

Accordingly, what is needed is a boat trailer auxiliary lighting system that includes the advantage of being mounted high on the boat trailer 120, as in the alternate prior art auxiliary lighting system 200, for safe operation in traffic. Mounting auxiliary signal lights on the boat trailer 120 facilitates use of the auxiliary signal lights without requiring the lights to be removed or disconnected at launch and remounted or connected when the boat is loaded. What is also needed is an auxiliary lighting system that mounts easily on existing trailer designs. What is also needed are lights with a longer useful life that run cooler than incandescent bulbs. Using cooler longer-life bulbs facilitates a signal light design in which the lights are permanently sealed, significantly decreasing the likelihood of damage from water and reducing inconvenience to the boat user.

### BRIEF SUMMARY OF THE INVENTION

The present invention has been developed in response to the present state of the art, and in particular, in response to the problems and needs in the art that have not yet been fully solved by currently available auxiliary lighting systems. Accordingly, the present invention has been developed to provide an apparatus, method, and system for auxiliary lighting that overcome many or all of the above-discussed shortcomings in the art.

In one aspect of the present invention, an apparatus for providing auxiliary lighting for a boat trailer includes a light assembly that emits light visible at a distance conforming to vehicle codes, a mounting element to attach the light assembly to a boat trailer, and a set of wires to connect the light assembly to existing trailer wiring. In some embodiments, the light assembly comprises a plurality of light-emitting diodes in a permanently sealed container. Light-emitting diodes have a long useful life. Enclosing the light-emitting diodes in a permanently sealed container protects the diodes and wire connections to protect them from water, salt, and other contaminants that could cause corrosion and premature failure of the apparatus.

In one embodiment, the mounting element is designed to conform to and mount over a trailer bunk board such as a 2×4, 2×6, 2×8, 2×10, or 2×12 board. To provide durability and additional protection to the light assembly, the side of the mounting element mounted toward the inside of the trailer may be much thicker than the side of the mounting element mounted toward the outside of the trailer. The mounting element may be fabricated from durable polyurethane plastic or other material that prevents damage to both the light assembly it houses and to the hull of the boat that slides against the mounting element as the boat is launched and loaded onto the trailer.

Attaching the mounting element to standard trailer bunk boards enables the auxiliary lighting system to be easily attached to a significant number of boat trailers currently in service. Attaching to a bunk board also places the auxiliary signal lights high on the trailer, which makes the lights visible from a greater distance and thus contributing to safe operation of the trailer in traffic. Placing the auxiliary signal lights high on the trailer also facilitates steering a boat toward the trailer when loading in dark conditions.

In another aspect of the present invention, a method for attaching auxiliary signal lights to a boat trailer includes providing a lighting assembly that emits visible light in a manner that conforms to vehicle codes, and providing a mounting element fashioned to attach to the end of a trailer bunk board. In one embodiment, the method for attaching auxiliary signal lights includes placing the mounting elements over the rear ends of trailer bunk boards, and fastening the mounting elements to the bunk boards to one side of the mounting element facing the outside of the trailer. Placing the mounting elements over standard dimension bunk boards provides secure attachment of the auxiliary lighting apparatus using low-cost materials. Fastening the mounting element to face the outside of the trailer protects the boat hull from being scratched as the boat is launched and loaded onto the trailer.

Various elements of the present invention are combined into a system for providing auxiliary lighting for a boat trailer comprising a boat trailer, a set of trailer bunk boards that support a boat on the boat trailer, a light assembly that emits light visible at a distance conforming to vehicle codes, and a set of wires to connect the container of light-emitting diodes to existing trailer wiring.

The present invention facilitates safe, reliable operation of a boat trailer in various traffic conditions. The present invention also increases user convenience and facilitates loading a boat onto a boat trailer in dark or low light conditions. These and other features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a rear view of a typical prior art auxiliary lighting system;

FIG. 2 is a rear view of an alternative prior art auxiliary lighting system;

FIG. 3 is a perspective view of one embodiment of an auxiliary lighting system of the present invention;

FIG. 4 is a front view of a left-side auxiliary lighting apparatus of the present invention;

FIG. 4A is a cross-sectional view of a right-side auxiliary lighting apparatus of the present invention;

FIG. 4B is an exploded view of one embodiment of a light assembly apparatus of the present invention;

FIG. 5 is a perspective view of an auxiliary lighting apparatus of the present invention;

FIG. 5A is a perspective view of an alternative embodiment of an auxiliary lighting apparatus 550 of the present invention;

FIG. 6 is a flow chart diagram illustrating one embodiment of an auxiliary lighting attachment method of the present invention;

FIG. 7 is a partially schematic side view of one embodiment of a first wiring configuration in accordance with the present invention; and

FIG. 8 is partially schematic side view of one embodiment of a second wiring configuration in accordance with the present invention.

### DETAILED DESCRIPTION OF THE INVENTION

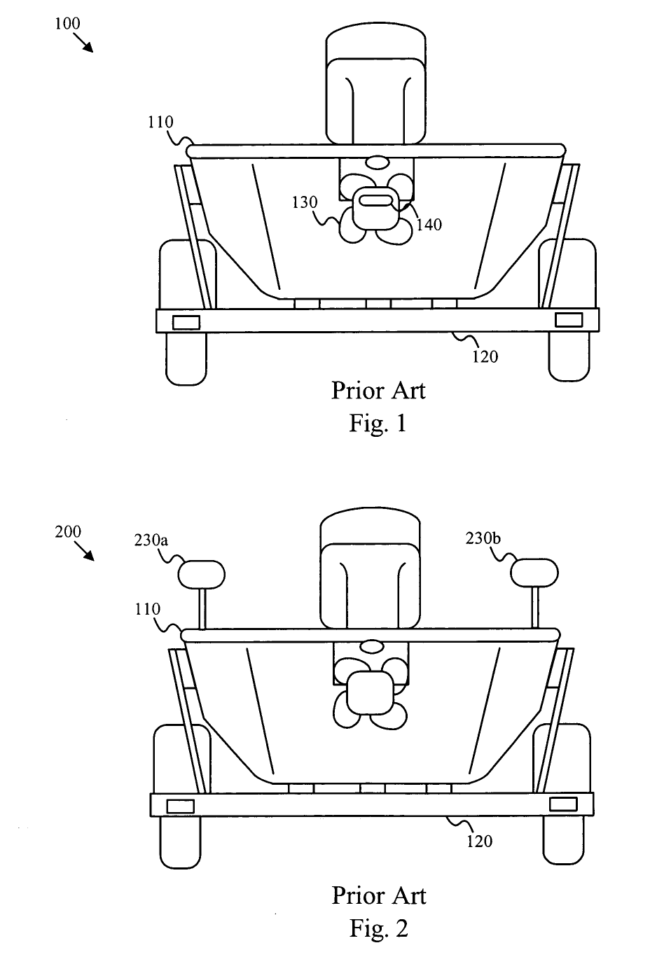

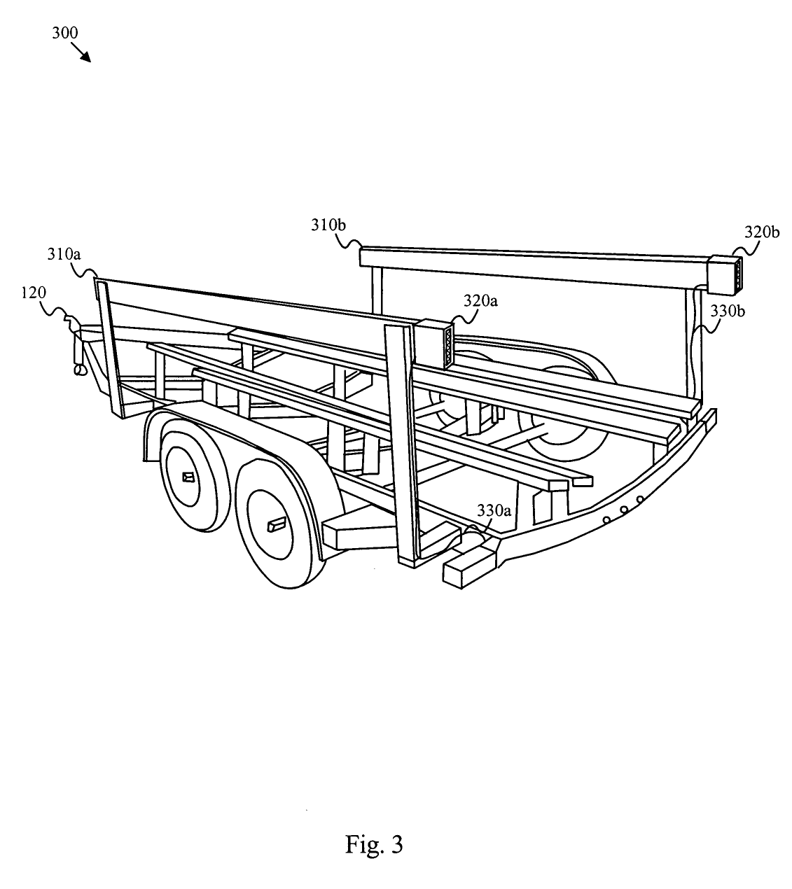

It will be readily understood that the components of the present invention, as generally described and illustrated in the Figures herein, may be arranged and designed in a wide variety of different configurations. Thus, the following more detailed description of the embodiments of the apparatus, method, and system of the present invention, as represented in FIGS. 1 through 8, is not intended to limit the scope of the invention, as claimed, but is merely representative of selected embodiments of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment and the described features, structures, or characteristics may be combined in any suitable manner in one or more embodiments

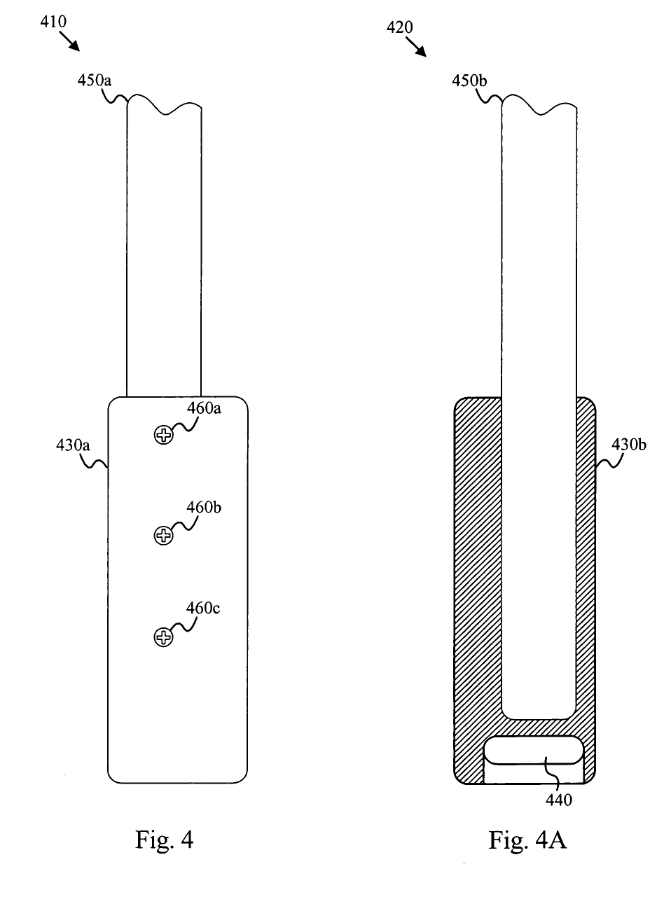

FIG. 3 is a perspective view illustrating one embodiment of an auxiliary lighting system 300 of the present invention. The auxiliary lighting system 300 includes a boat trailer 120, boat bunk boards 310a and 310b, auxiliary signal lights 320a and 320b, and connecting wires 330a and 330b. In the preferred embodiment, the boat bunk boards 310 are commonly used bunk boards such as 2×4, 2×6, 2×8, 2×10, or 2×12 boards. In a common boat trailer design, the hull of the boat is supported by one or more pair of horizontal boards, known as bunk boards, that run the length of the trailer bed. The preferred embodiment facilitates manufacturing the auxiliary signal lights 320 in quantity.

In certain embodiments (not shown), the auxiliary signal lights 320 are configured to respond to control signals generated by a wireless controller (not shown) that is uniquely associated with the auxiliary signal lights 320. In one embodiment, the wireless controller may be magnetically attached at a convenient location on rear end of the vehicle or the front end of the trailer and electrically connected to the auxiliary wiring of the vehicle.

In the depicted embodiment, the connecting wires 330 connect the auxiliary signal lights 320 to the boat trailer 120 wiring. The number of wires included in the connecting wires 330 bundle depends on the signal light functions the auxiliary signal lights 320 are configured to provide. For example, if the auxiliary signal lights 320 only provide tail light function, only 2 wires may be required. If the auxiliary signal lights 320 provide tail light, turn signal, back up, and brake light functions, more wires may be required.

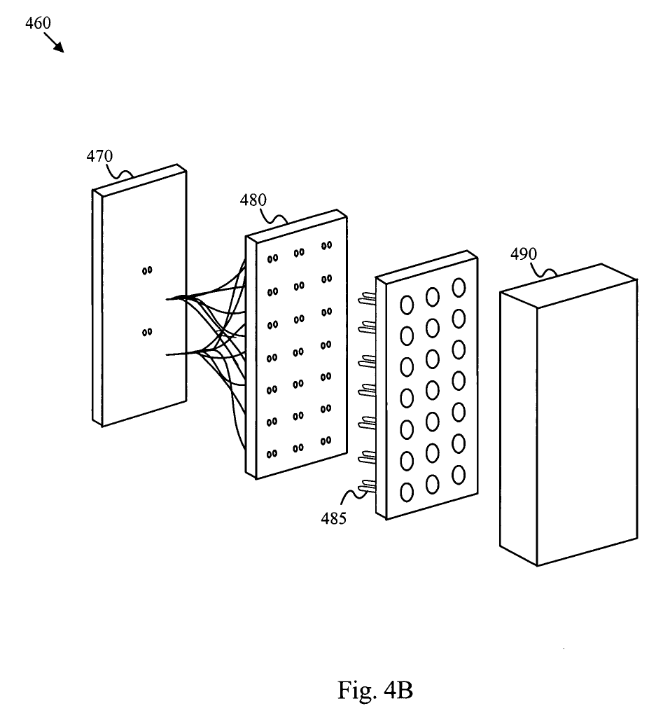

FIGS. 4 and 4A are respectively a front view and a cross-sectional view of left and right auxiliary signal lights 410 and 420. Also shown are mounting elements 430a and 430b, light assembly 440, trailer bunk boards 450a and 450b, and attachment elements 460a, 460b, and 460c. The light assembly in the left auxiliary signal light 410 is not visible in FIG. 4 because the left auxiliary signal light 410 is enclosed in and covered by the mounting element 430a.

In FIG. 4A, the right auxiliary signal light 420 is depicted in a cross-sectional view, showing that the mounting element 430b slides over and encompasses the trailer bunk board 450b. The left auxiliary signal light 410 is depicted in a front view, depicting the attaching screws 460 that attach the mounting elements 430 to the trailer bunk boards 450. In the depicted embodiment, the mounting element 430 completely encompasses a bunk board. In another embodiment, the mounting element 430 has an open face (such as the lower or upper face) that facilitates substantially encompassing bunk boards of various sizes, such as 2×4, 2×6, 2×8, 2×10, and 2×12 bunk boards.

In the depicted embodiment, the sides of the mounting elements 430 that face the inside of the boat trailer 120 are thicker than the sides that face outside. The additional thickness on the inside face of the mounting elements 430 provides additional durability and protection for the light assemblies 440. The mounting element 430 may be fabricated from mar-resistant polyurethane plastic, or other durable material. The mounting element 430 may also function as a bumper and guide for the hull of the boat as it is launched and loaded onto the boat trailer 120.

In some embodiments, the light assemblies 440 are permanently sealed containers, containing a plurality of light-emitting diodes. The mounting elements 430 may be constructed with a cavity that receives and protects the light assemblies 440. In one embodiment, the light assemblies 440 may be attached to the mounting elements 430 with adhesive or the light assemblies 440 and the mounting elements 430 may be constructed as a single module. The mounting elements 430 may be attached to the trailer bunk boards 450 using a suitable fastening mechanism, examples of which include screws, adhesive, and nails.

FIG. 4B is an exploded view of one embodiment of a light assembly 460 the present invention. The depicted light assembly 460 is one example of the light assembly 440 of FIGS. 4 and 4A. The light assembly 460 includes a sealed container base 470, a wiring socket 480, a plurality of light-emitting diodes 485, and a sealed container cover 490.

The light assembly 460 seals a plurality of light-emitting diodes 485 between the sealed container base 470 and sealed container cover 490 to protect them from water, salt, and other contaminants that would reduce the useful life of the light emitting diodes 485 and connected wiring socket 480. The light assembly 460 may be attached to the mounting element 430, in the manner illustrated for the light assembly 460 in FIG. 4.

The wiring socket 480 and the plurality of light-emitting diodes 485 may be permanently sealed together to protect the electrical connections to the plurality of light-emitting diodes 485. The sealed container cover 490 may be constructed of a red, white, or amber translucent material to color the light emitted by the light assembly 460 to conform with traffic codes. In one embodiment, the base and cover are fabricated from injection molded plastic as a single contiguous package that encapsulates the wiring socket 480 and the plurality of light-emitting diodes 485.

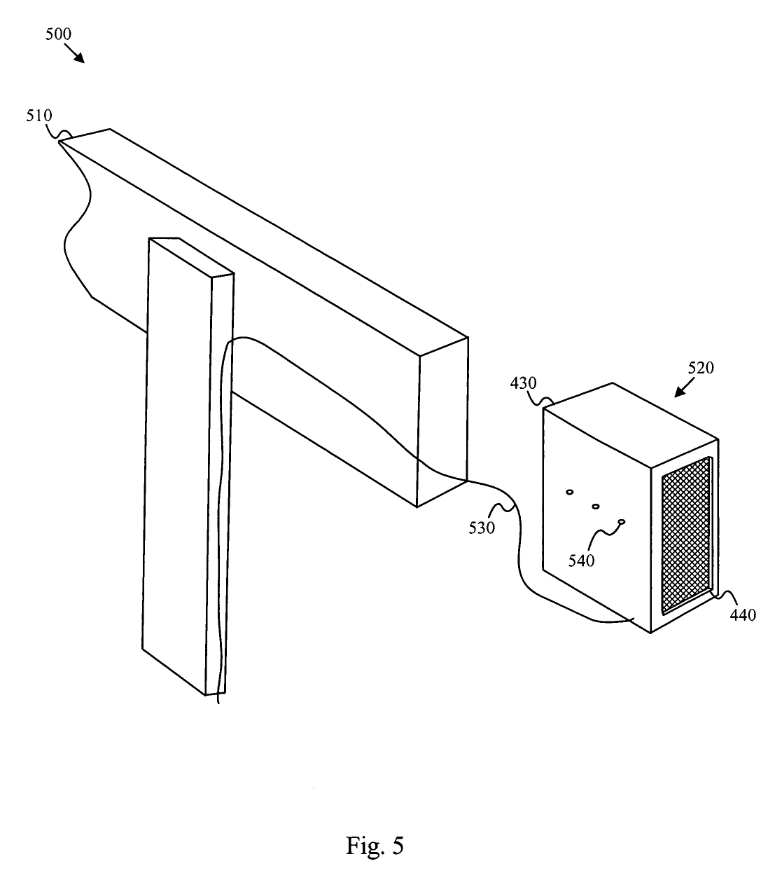

FIG. 5 is a block diagram illustrating a detailed view of an auxiliary lighting apparatus 500 of the present invention. The auxiliary lighting apparatus 500 includes a trailer bunk board 510, an auxiliary signal light 520, a mounting element 430, a light assembly 440, a connecting wire 530, and fasteners 540. The fasteners 540 may be selected to permit the auxiliary lighting apparatus 500 to be easily removed from the trailer bunk board 510 for attachment to another trailer. In one embodiment, the fasteners 540 comprise a locking mechanism that requires a key to attach or remove the mounting element from the trailer bunk board. The auxiliary lighting apparatus 500 may mount over a standard 2×4, 2×6, 2×8, 2×10, or 2×12 trailer bunk board 510 to provide lights on the upper end of a boat trailer 120. Mounting the auxiliary lighting apparatus 500 high on the boat trailer 120 increases the visibility of the boat trailer 120 in traffic, thereby increasing safety.

FIG. 5 is a perspective view of a left side auxiliary signal light 520. The mounting element 430 in the embodiment of FIG. 5 is constructed to conform to and mount over a trailer bunk board 510 and includes an integral cavity to contain and protect the light assembly 440. In the depicted embodiment, fasteners 540 on the side of the auxiliary signal light 520 facing the outside of the boat trailer 120 attach the auxiliary signal light 520 to the trailer bunk board 510. In other embodiments, the auxiliary signal light 520 is attached to the trailer bunk board 510 using fasteners through the top side of the auxiliary signal light 520, or using adhesive. Attaching the auxiliary signal light 520 in this manner prevents the hull of the boat 110 from being scratched as it is launched and loaded onto the boat trailer 120. In some embodiments, the mounting element 430 does not fully enclose the trailer bunk board 510, but comprises a lip configured to adjoin the edge of a bunk board 510.

FIG. 5A is a perspective view of an auxiliary lighting apparatus 550 of the present invention. The auxiliary lighting apparatus 550 is an alternate embodiment of the auxiliary lighting apparatus 500 depicted in FIG. 5 and includes substantially the same components. One significant difference is that the mounting element 430 is constructed with a lip that adjoins and conforms to the edge of the trailer bunk board 510, but does not fully encompass the trailer bunk board 510. This embodiment of the mounting element 430 does not provide the same advantages as the mounting element 430 depicted in FIG. 5, but will mount on a trailer bunk board 510 of non-standard dimensions.

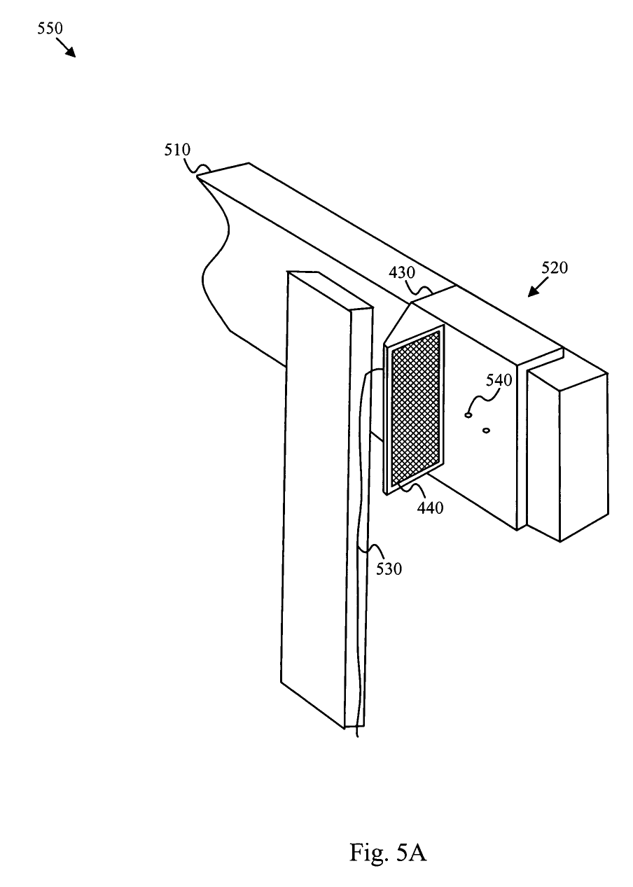

FIG. 6 is a flow chart diagram illustrating one embodiment of an auxiliary lighting attachment method 600 of the present invention. The auxiliary lighting attachment method 600 includes a provide mounting element step 610, an insert light assembly step 620, and an attach mounting element step 630. The depicted auxiliary lighting attachment method 600 uses a mounting element 430 to attach a light assembly 440 to the end of standard trailer bunk boards 510. Constructing the mounting element 430 to attach to standard trailer bunk boards 510 facilitates fast and easy attachment of the auxiliary signal lights 410 and 420 to a large number of existing boat trailers 120.

The provide mounting element step 610 provides a mounting element configured to attach to an end of a trailer bunk board. The mounting element may include a cavity configured to receive and protect the light assembly 440. The light assembly 440 may also include a plurality of light-emitting diodes 485.

The insert light assembly step 620 inserts the light assembly 440 within the mounting element 430. The insert light assembly step 640 may comprise affixing the light assembly to the mounting element 430 using adhesive or screws.

The attach mounting element step 630 attaches the mounting element 430 of the auxiliary signal light 520 to the end of a trailer bunk board 510. The mounting element 430 may be mounted with the thicker side toward the inside of the boat trailer 120. In one embodiment, fasteners 540, such as screws, are inserted through the side of the auxiliary signal light 520 facing the outside of the boat trailer 120. Attaching the auxiliary signal light 520 in this manner prevents the hull of the boat 110 from being scratched as it is launched and loaded onto the boat trailer 120.

In conjunction with the attach mounting element step 630, electrical connections to the auxiliary signal lights may be made. The precise connections made may vary according to the particular wiring configuration used. After the attach mounting element step 630, the auxiliary lighting attachment method 600 ends 650.

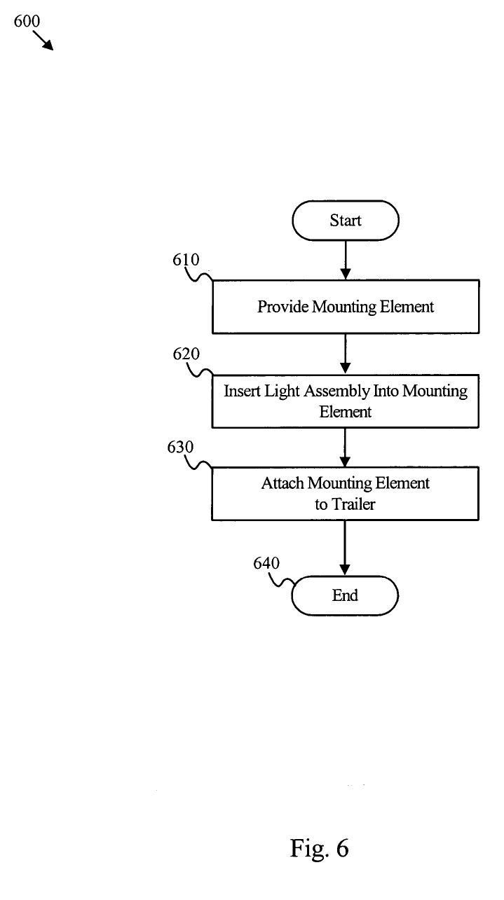

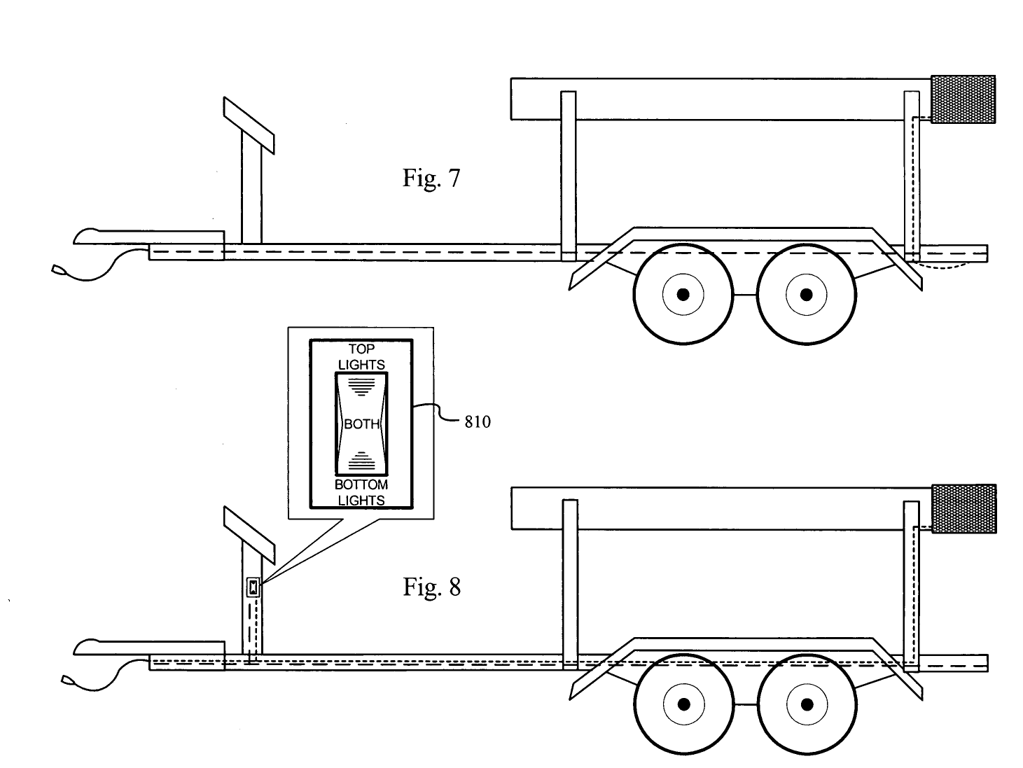

FIGS. 7 and 8 depict two specific wiring configurations that maybe used in accordance with the present invention. In particular, FIG. 7 depicts connecting the auxiliary signal lights directly to existing lights on the boat trailer, while FIG. 8 depicts connecting the auxiliary signal lights to a control switch 810 that enables individual control of the existing trailer lights and auxiliary signal lights of the present invention. As depicted in FIG. 8, the control switch 810 may include settings that enable operation of the existing trailer lights, auxiliary signal lights, or both systems.

The present invention facilitates safe operation of a boat trailer and increases convenience to a boat user. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for providing auxiliary lighting for a trailer, the apparatus comprising:
a light assembly configured to emit visible light; and
a mounting element configured to conform to an end of a trailer bunk board, the mounting element comprising a cavity configured to receive and protect the light assembly.

2. The apparatus of claim 1, wherein the mounting element is further configured to encompass one end of the trailer bunk board.

3. The apparatus of claim 1, wherein the light assembly comprises a plurality of light emitting diodes in a permanently sealed container.

4. The apparatus of claim 1, wherein the mounting element comprises a first wall that is substantially thicker than an opposing second wall, the first wall disposed to contact a boat.

5. The apparatus of claim 1, wherein the mounting element comprises a mar-resistant surface.

6. The apparatus of claim 1, wherein the mounting element comprises a polyurethane plastic.

7. The apparatus of claim 1, wherein the mounting element attaches to the end of the trailer bunk board with the use of a fastener selected from the group consisting of a screw, an adhesive layer, a nail, and a lock assembly.

8. The apparatus of claim 1, wherein the mounting element is removably attached to the end of the trailer bunk board.

9. The apparatus of claim 1, wherein the light assembly is further configured to respond to wireless control signals.

10. The apparatus of claim 1, wherein the light assembly is waterproof.

11. The apparatus of claim 1, wherein the light assembly is airtight.

12. The apparatus of claim 1, wherein the light assembly comprises a translucent material having a color selected from the group consisting of red, white, and amber.

13. The apparatus of claim 1, wherein the light assembly emits light visible at a distance of more than 500 feet, in a manner conforming to vehicle codes.

14. An apparatus for providing auxiliary lighting for a trailer, the apparatus comprising:
a light assembly comprising a plurality of light emitting diodes in a permanently sealed container, the light assembly configured to emit visible light in a manner conforming to vehicle codes; and
a mounting element configured to receive the light assembly, the mounting element further configured to conform to a trailer bunk board.

15. The apparatus of claim 14, wherein the mounting element comprises a lip configured to adjoin a bunk board edge.

16. An apparatus for providing auxiliary lighting for a trailer, the apparatus comprising:
a light assembly configured to emit visible light in a manner conforming to vehicle codes;
a mounting element configured to receive the light assembly, the mounting element further configured to substantially encompass one end of a trailer bunk board.

17. The apparatus of claim 16, wherein the light assembly comprises a plurality of light emitting diodes in a permanently sealed container.

18. The apparatus of claim 16, wherein the mounting element comprises a cavity configured to receive and protect the light assembly.

19. The apparatus of claim 16, wherein the mounting element partially encompasses one end of the trailer bunk board.

20. The apparatus of claim 16, wherein the mounting element substantially encompasses one end of the trailer bunk board.

21. A method for providing auxiliary lighting for a trailer, the method comprising:
providing a light assembly configured to emit visible light in a manner conforming to vehicle codes; and
providing a mounting element configured to conform to an end of a trailer bunk board, the mounting element comprising a cavity configured to receive and protect the light assembly.

22. The method of claim 21, further comprising attaching the mounting element to the end of a trailer bunk board.

23. The method of claim 21, further comprising inserting the light assembly within the mounting element.

24. A system for providing auxiliary lighting for a boat trailer, the system comprising:
a trailer configured to carry a boat;
a plurality of trailer bunk boards configured to contain the boat within the trailer;
a light assembly mounted on a trailer bunk board that is substantially raised above a bed of the trailer; and
a plurality of connecting wires configured to connect the light assembly to electrical circuits.

25. The system of claim 24, further comprising a mounting element configured to conform to an end of a trailer bunk board, the mounting element comprising a cavity configured to receive and protect the light assembly.

26. The system of claim 24, wherein the light assembly comprises a plurality of light emitting diodes in a permanently sealed container.

27. The system of claim 24, wherein the connecting wires comprise wires connecting the light assembly to a boat trailer signal light wiring.

28. The system of claim 27 wherein the connecting wires further comprise wires connecting the light assembly to an electrical circuit selected from the group consisting of direct electrical current, ground, turn signal, brake, and back-up circuits.

29. The system of claim 24, wherein the plurality of trailer bunk boards are selected from the group consisting of 2×4 bunk boards, 2×6 bunk boards, 2×8 bunk boards, 2×10 bunk boards, and 2×12 bunk boards.
